(19) United States
(12) Patent Application Publication
(10) Pub. No.: US 2026/0320175 A1
(43) Pub. Date: Oct. 15, 2026

(54) PREVENTING FREEZE ATTACKS RELATED TO SOFTWARE UPDATES

(71) Applicant: Red Hat, Inc., Raleigh, NC (US)

(72) Inventors: Andrea Cosentino, Milan (IT); Paolo Antinori, Milan (IT)

(73) Assignee: Red Hat, Inc., Raleigh, NC (US)

(21) Appl. No.: 19/175,450

(22) Filed: Apr. 10, 2025

(51) Int. Cl. G06F 21/54; G06F 21/51

(52) U.S. Cl. CPC G06F 21/54; G06F 21/51

(57) ABSTRACT

Freeze attacks can be prevented using the techniques described herein. In one example, a computing device can receive a software update for a software program. The computing device can receive the software update from an update provider through a first communication channel. Based on receiving the software update, the computing device can transmit a request associated with the software update to a remote server through a second communication channel, the second communication channel being different from the first communication channel. The computing device can receive a response to the request from the remote server. The response can indicate that the software update is outdated. Based on the response indicating that that software update is outdated, the computing device can discard the software update from the computing device without installing the software update. Discarding the software update in this way can help prevent against a freeze attack.

### TECHNICAL FIELD

The present disclosure relates generally to cybersecurity. More specifically, but not by way of limitation, this disclosure relates to preventing freeze attacks related to software updates on a computing device.

### BACKGROUND

A software update “freeze attack” is a cyberattack in which an attacker intercepts update requests from a client device and repeatedly presents the same, outdated software update to the client device, which prevents the client device from receiving and installing a legitimate software update. This prevents the client from updating to a newer version of the software, which allows the attacker to continue exploiting vulnerabilities in the currently installed version of the software on the client device. Through this process, the attacker tricks the client device into thinking it is obtaining new software updates when in fact it repeatedly obtaining the same, outdated software update.

### BRIEF DESCRIPTION OF THE DRAWINGS

FIG. 1 shows a block diagram of an example of a system for preventing freeze attacks related to software updates according to some aspects of the present disclosure.

FIG. 2 shows a block diagram of another example of a system for preventing freeze attacks related to software updates according to some aspects of the present disclosure.

FIG. 3 shows a flowchart of an example of a process for preventing freeze attacks related to software updates according to some aspects of the present disclosure.

### DETAILED DESCRIPTION

One type of cybersecurity attack is a “freeze attack.” During a freeze attack, an attacker tricks a computing device into installing an outdated update for a software program rather than a new update, because the new update fixes a vulnerability that the attacker wants to exploit. The attacker can perform a freeze attack by positioning itself as a man-in-the-middle between the computing device and an update source. When the computing device transmits an update request that is intended for the update source, the attacker can intercept the update request and deliver the outdated software update in reply. Upon receiving the outdated software update, the computing device installs the outdated software update, none-the-wiser to the fact that it installed an old update rather than a new update. As a result, the computing device remains susceptible to the vulnerability. This also wastes the computing device’s resources, because it expends processing power and memory in reinstalling an update that is already installed.

Some examples of the present disclosure can overcome one or more of the above problems by externally validating a received software update to confirm it is a new update rather than an outdated update. For example, a computing device can transmit an update request for a software program along a first communication channel. The destination of the update request can be intended to be a legitimate update source, such as a developer of the software program. If an attacker has inserted itself along the first communication channel, the attacker can intercept the update request and provide an outdated software update to the client device to perform a freeze attack. To mitigate the freeze attack, before installing the received software update, the computing device can interact with a remote server to perform a validation process on the received software update. For example, the computing device can transmit a request associated with the received software update to a remote server through a second communication channel, which is different from the first communication channel to prevent the attacker from intercepting the request. The remote server can be operated by a trusted third party. The computing device can receive a response to the request from the remote server. If the response indicates that the received software update is outdated, the computing device can discard it without installing the software update. Otherwise, the computing device can install the software update. By using a trusted remote server to validate the received software update, the system can help mitigate a freeze attack and avoid wasting resources installing the update.

In some examples, upon detecting that the software update is outdated, the computing device can further blocklist the software update. For example, the computing device can add a unique identifier of the software update to a blocklist, which is a list of blocked software updates. Each time the computing device receives a software update, it can compare the software update’s unique identifier to the blocklist. If the software update’s unique identifier is on the blocklist, the computing device can automatically discard the software update without installing it and without contacting the remote server again. This can help conserve bandwidth by reducing communications between the computing device and the remote server. This can also reduce the effectiveness of a freeze attack because, because no matter how many times and how frequently the attacker transmits the outdated software to the computing device, the software update is automatically blocked (e.g., detected and removed) each time.

In some examples, upon detecting that the software update is outdated, the computing device may request a newer software update from the remote server. For example, the computing device may request the most recent update for the software program from the remote server. In response, the remote server can provide the requested software update to the computing device for installation. In this way, the remote server can act as a backup update source if the first communication channel has been compromised.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

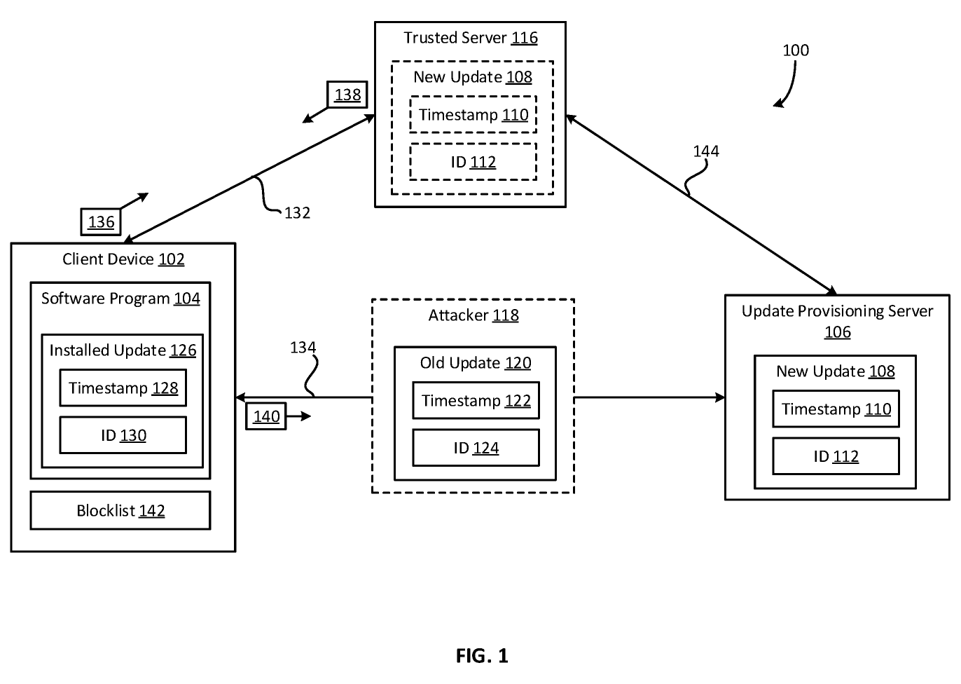

FIG. 1 shows a block diagram of an example of a system 100 for preventing freeze attacks related to software updates according to some aspects of the present disclosure. The system 100 includes a client device 102, such as a laptop computer, desktop computer, mobile phone, tablet, e-reader, virtual reality (VR) headset, wearable device such as a smart watch, Internet of Things (IOT) device, server, or electronic control unit (ECU) for a vehicle. The client device 102 includes a software program 104, such as an application, serverless function, microservice, or firmware. The client device 102 may have previously installed an update 126 for the software program 104. The installed update 126 can have corresponding metadata, such as a timestamp 128 and unique identifier 130. The timestamp 128 may be a release date or creation date for the installed update 126.

The installed update 126 may be provided by an update provisioning server 106. The update provisioning server 106 may be associated with (e.g., owned or operated by) an update originator, which can develop and/or release legitimate updates for the software program 104. The client device 102 may be associated with an entity that is different from the update originator. For example, the client device 102 may be associated with an end user of the software program 104, whereas the update provisioning server 106 may be associated with an organization that develops the software program 104. In this scenario, the end user may not be part of the organization.

In a conventional scenario, the client device 102 can transmit update requests to the update provisioning server 106. The client device 102 can transmit such update requests periodically or in response to detecting events. If a new update 108 is available, the update provisioning server 106 can transmit the new update 108 to the client device 102 for installation thereon. In this scenario, the client device 102 and the update provisioning server 106 can communicate via a first communication channel 134. The first communication channel 134 can include a specific network pathway between the client device 102 and the update provisioning server 106. The specific network pathway can include one or more public networks and/or one or more private networks, such as the Internet or a local area network (LAN) respectively. If an attacker 118 inserts itself into the first communication channel 134, the attacker 118 may operate as a man-in-the-middle and intercept the update requests from the client device 102, so that they never reach the update provisioning server 106. Upon intercepting an update request, the attacker 118 may respond by providing an old update 120 to the client device 102. In many cases, the old update 120 will be the same as the update 126 already installed on the client device 102. Because the client device 102 normally does not validate the received update 120, it will install the old update 120 under the impression that it is a legitimate new update. In this way, the attacker 118 can trick the client device 102 into installing an old update, typically because the old update has a vulnerability (or fails to fix a vulnerability) that the attacker 118 can exploit.

To help mitigate the above problem, the system 100 can include a trusted server 114. In some examples, the trusted server 114 and the update provisioning server 106 may be associated with (e.g., owned or operated by) different entities. For instance, update provisioning server 106 may be located in a first computer network operated by a first entity, and the trusted server may be located in a second computer network operated by a second entity, where the first computer network and the first entity are different from the second computer network and the second entity, respectively. The first and second computer networks may be private networks. In other examples, the trusted server 114 and the update provisioning server 106 may be associated with the same entity. For example, the trusted server 114 and the update provisioning server 106 can be located in the same computer network (e.g., the same private network) or different computer networks associated with the same entity. Either way, the goal is for the trusted server 116 to function as an independent validator of updates received by the client device 102.

The system 100 can operate as follows. When a new update 108 becomes available for the software program 104, its details can be communicated to the trusted server 116. For example, the update provisioning server 106 can transmit the timestamp 110 and unique identifier 112 associated with the new update 108 to the trusted server 116, as represented by the dashed boxes in FIG. 1. The timestamp 110 may be a release date or creation date for the update 108. The update provisioning server 106 may also transmit the new update 108 itself to the trusted server 116, as represented by the dashed box in FIG. 1. It will be appreciated that although the new update 108 is “new” relative to an older update, it may or may not be the most recent update for the software program 104. For example, the new update 108 may simply be more recent than the installed update 126 or the received update 120, but may not necessarily be the most recent update for the software program 104.

At a later point in time, the client device 102 can transmit an update request 140 intended for the update provisioning server 106. The update request 140 can be a request for any recent updates for the software program 104. The client device 102 can transmit the update request 140 via the first communication channel 134. As described above, the attacker 118 may intercept the update request 140 and respond by providing an old update 120 to the client device 102. In conjunction with providing the old update 120 to the client device 102, the attacker 118 may also provide details about the old update 120 to the client device 102, such as its timestamp 122 and unique identifier 124. The timestamp 122 may be a release date or creation date for the old update 120. Those details may be embedded in the update package, for example as metadata. It will be appreciated that such details may not be modifiable in the update package without impacting its digital fingerprint (e.g., a digital signature or checksum), which would tip off the recipient to a problem with the update package. Thus, attackers normally do not modify this information.

At this point, unlike the conventional approach, the client device 102 can transmit a request 136 to the trusted server 116. The client device 102 can transmit the request 136 to the trusted server 116 via a second communication channel 132 that is different from the first communication channel 134. This may circumvent the attacker 118 who is unable to intercept messages on the second communication channel 132.

The first communication channel 134 can be a logical communication pathway from the client device 102 to the update provisioning server 106. Similarly, the second communication channel 132 can be a logical communication pathway from the client device 102 to the trusted server 116. These channels can be differentiated based on network configurations, protocols, or physical transmission mediums to enhance security and resilience against freeze attacks. For example, the first communication channel 134 can be established using a specific network pathway, such as a public network like the Internet or a private network such as a corporate intranet. The second communication channel 132 may bypass the conventional network pathway by relying on a secure and isolated configuration, such as a dedicated private network or a virtual private network (VPN) tunnel specifically configured to communicate with the trusted server 116. In some examples, the first communication channel 134 can include a computer network that is excluded from the second communication channel 132. By separating the communication channels, the system 100 ensures that an attacker 118 who intercepts the first communication channel 134 cannot easily gain access to the second communication channel 132.

In some examples, the first communication channel 134 and the second communication channel 132 can use different communication protocols to further reduce the risk of interception by an attacker 118. The first communication channel 134 can use a first communication protocol that may be selected based on convenience or compatibility with the update provisioning server 106, while the second communication channel 132 can use a second communication protocol that may be chosen based on its enhanced security features or resistance to cyberattacks. For example, the first communication channel 134 may use a standard protocol such as Hypertext Transfer Protocol (HTTP) or Hypertext Transfer Protocol Secure (HTTPS), while the second communication channel 132 may use protocols such as Transport Layer Security (TLS), Secure Shell (SSH), or Message Queuing Telemetry Transport (MQTT) with encryption enabled. Additionally, the second communication channel 132 may incorporate advanced security measures such as mutual authentication, certificate pinning, or cryptographic key exchanges to prevent unauthorized access.

In some examples, the first communication protocol can include a first wireless communication protocol. Additionally or alternatively, the second communication protocol can include a second wireless communication protocol, which may be different from the first wireless communication protocol. For instance, the first communication channel 134 may rely on 802.11 Wi-Fi protocols, and the second communication channel 132 can use alternative wireless communication protocols such as Zigbee, Bluetooth®, or cellular communication standards like Long-Term Evolution (LTE) or 5G. These different wireless protocols can enhance the physical separation of the channels, making it more challenging for the attacker 118 to intercept communications across both channels.

It will be appreciated that the update provisioning server 106 can communicate with the trusted server 116 via a third communication channel 144, which is different from the first communication channel 134 and second communication channels 132. The third communication channel 144 can be a logical communication pathway from the update provisioning server 106 and the trusted server 116. The third communication channel 144 may use a third communication protocol, which may be the same as or different from the first communication protocol and/or second communication protocol. For example, the third communication channel 144 may use a wireless communication protocol that is different from that of the first communication channel 134 and/or the second communication channel 132.

Through the second communication channel 132, the trusted server 116 can receive the request 136. In some examples, the request 136 may include details of (e.g., metadata about) the received update 120, such as its timestamp 122 and its unique identifier 124. The trusted server 116 can then compare some or all of the details of the received update 120 to those of the new update 108 to determine whether they match. For example, the trusted server 116 can compare the timestamp 122 of the received update 120 to the timestamp 110 of the new update 108 to determine whether they match. If they do not match and the timestamp 122 of the received update 120 is older, the trusted server 116 can determine that the received update 120 is outdated. As another example, the trusted server 116 can compare the unique identifier 124 of the received update 120 to the unique identifier 112 of the new update 108 to determine whether they match. If they do not match, the trusted server 116 can determine that the received update 120 is outdated. One or both of these validation processes can be performed by the trusted server 116 for the received update 120, so as to determine whether the received update 120 is outdated or current (e.g., the newest update available). If the trusted server 116 determines that the received update 120 is outdated, the trusted server 116 can transmit a response 138 to the request 136 to the client device 102. The trusted server 116 can transmit the response 138 via the second communication channel 132. The response 138 can indicate that the received update 120 is outdated. For example, the response 138 can include a flag that indicates the received update 120 is outdated. Based on the response 138, the client device 102 can determine that the received update 120 is outdated.

In other examples, the trusted server 116 can receive the request 136 and transmit a response 138 indicating the timestamp 110 and/or unique identifier 112 of the new update 108. The trusted server 116 can transmit the response 138 via the second communication channel 132. The client device 102 can then perform one or both of the abovementioned validations based on the timestamp 110 and/or unique identifier 112. For example, the client device 102 can compare the timestamp 122 of the received update 120 to the timestamp 110 of the new update 108 to determine whether they match. If they do not match and the timestamp 122 of the received update 120 is older, the client device 102 can determine that the received update 120 is outdated. As another example, the client device 102 can compare the unique identifier 124 of the received update 120 to the unique identifier 112 of the new update 108 to determine whether they match. If they do not match, the client device 102 can determine that the received update 120 is outdated. Thus, the validations can be performed on the trusted server 116 or the client device 102 in various examples.

If the client device 102 determines that the received update 120 is outdated, the client device 102 can discard the received update 120 without installing it. In some examples, the client device 102 may also add the received update 120 (e.g., its unique identifier 124) to a blocklist 142. That way, if the client device 102 receives the same update 120 again in the future (e.g., from the attacker 118), the client device 102 can automatically determine that the received update 120 is on the blocklist 142 and discard the update 120, without installing it and without contacting the trusted server 116 again. This can conserve bandwidth and computing resources. Through this process, the system 100 can mitigate a freeze attack attempted by the attacker 118.

In some examples, upon detecting that the received software update 120 is outdated, the client device 102 may request the new update 108 from the trusted server 116. In response, the trusted server 116 can provide the new update 108 to the client device 102, which can install the update 108. Installing the update 108 can fix the vulnerability that the attacker 118 is attempting to exploit. In this way, the trusted server 116 can act as a backup update source if the first communication channel 134 has been compromised.

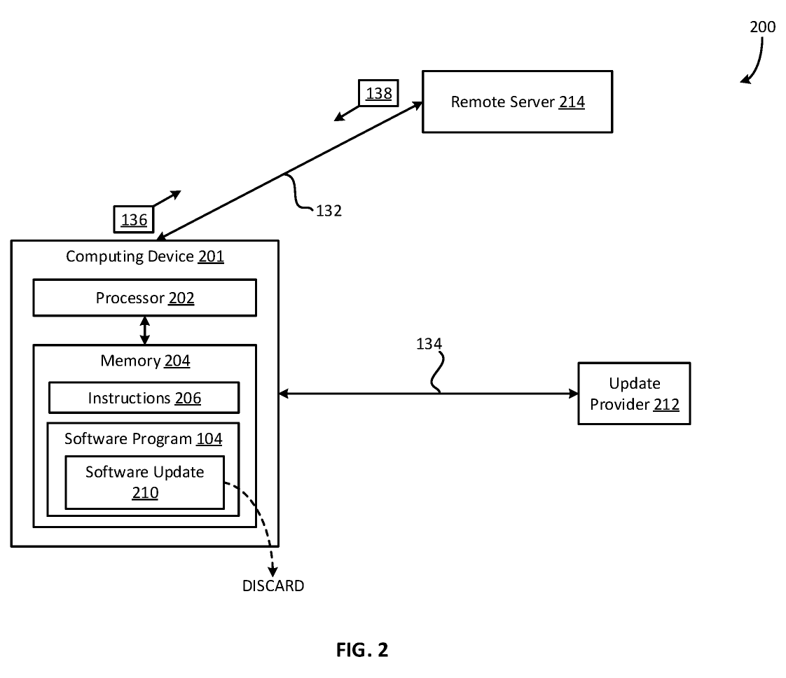

Turning now to FIG. 2, shown is a block diagram of another example of a system 200 for preventing freeze attacks related to software updates according to some aspects of the present disclosure. The system 200 includes a processor 202 communicatively coupled to a memory 204. In some examples, the processor 202 and memory 204 may be included in a computing device 201, such as the client device 102 of FIG. 1.

The processor 202 can include one processing device or multiple processing devices. Non-limiting examples of the processor 202 include a Field-Programmable Gate Array (FPGA), an application-specific integrated circuit (ASIC), a microprocessor, or any combination of these. The processor 202 can execute instructions 206 stored in the memory 204 to perform operations, such as any of the operations described above with respect to the client device 102. In some examples, the instructions 206 can include processor-specific instructions generated by a compiler or an interpreter from code written in any suitable computer-programming language, such as C, C++, C#, Python, or Java.

The memory 204 can include one memory device or multiple memory devices. The memory 204 can be volatile or non-volatile, such that the memory 204 retains stored information when powered off. Non-limiting examples of the memory 204 include electrically erasable and programmable read-only memory (EEPROM), flash memory, or any other type of non-volatile memory. At least some of the memory device can include a non-transitory computer-readable medium from which the processor 202 can read the instructions 206. A computer-readable medium can include electronic, optical, magnetic, or other storage devices capable of providing the processor 202 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 206.

In some examples, the processor 202 can execute the instructions 206 to perform one or more operations. For example, the processor 202 can receive a software update 210 for a software program 104. The processor 202 can receive the software update 210 from an update provider 212 (e.g., an attacker or other source) through a first communication channel 134. Based on receiving the software update 210, the processor 202 can transmit a request 136 associated with the software update 210 to a remote server 214 through a second communication channel 132, the second communication channel 132 being different from the first communication channel 134. The remote server 214 may be a trusted server, such as the trusted server 116 of FIG. 1. The processor 202 can receive a response 138 to the request 136 from the remote server 214. The response 138 can indicate whether the software update 210 is outdated. Based on the response 138 indicating that that software update 210 is outdated, the processor 202 can discard (e.g., delete) the software update 210 from the computing device 201, without installing the software update 210. This can help prevent against a freeze attack.

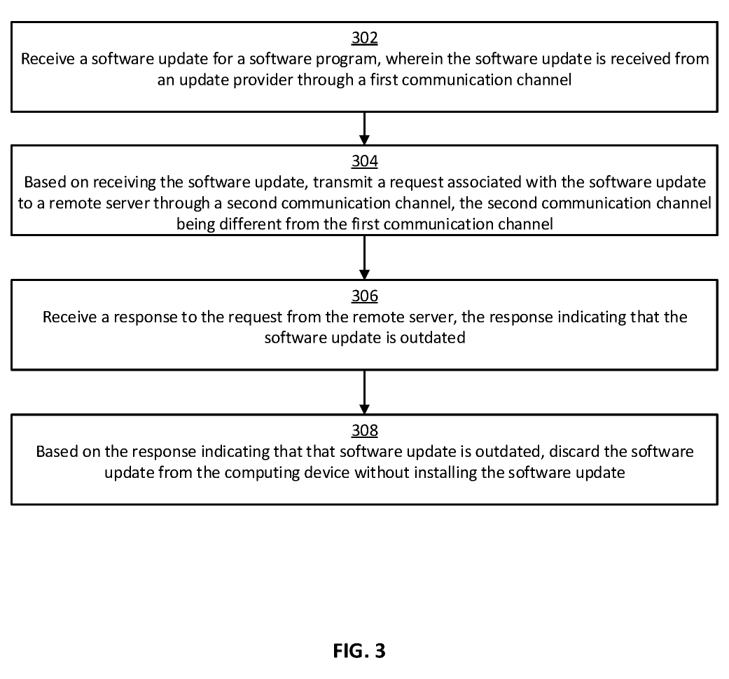

Turning now to FIG. 3, shown is a flowchart of an example of a process for preventing freeze attacks related to software updates according to some aspects of the present disclosure. Other examples can include more operations, fewer operations, different operations, or a different sequence of operations than is shown in FIG. 3. The operations of FIG. 3 are described below with reference to the components of FIGS. 1-2 described above.

In block 302, processor 202 receives a software update 210 for a software program 104. The software program 104 may include a software application, firmware, a microservice, etc. The processor 202 can receive the software update 210 through a first communication channel 134. The first communication channel 134 can be a specific communication pathway between the processor 202 and a trusted source of legitimate updates (e.g., an update provisioning server of a legitimate software developer).

The processor 202 can receive the software update 210 from an update provider 212. The update provider 212 may be an attacker or other untrusted source that has inserted itself into the first communication channel 134. However, the processor 202 may not realize it is receiving the software update 210 from the untrusted source, which may operate in a transparent manner. Rather, the processor 202 may “think” it has received a requested software update from the trusted source that is on the other end of the first communication channel 134.

In block 304, based on receiving the software update 210, the processor 202 transmits a request 136 associated with the software update 210 to a remote server 214 through a second communication channel 132. The second communication channel 132 is different from the first communication channel 134. The remote server 214 may be a trusted server, as shown in FIG. 1. Assuming the second communication channel 132 has not been infiltrated by the attacker, the second communication channel 132 can serve as a secure communication pathway between the processor 202 and the remote server 214.

In block 306, the processor 202 receives a response 138 to the request 136 from the remote server 214. The response 138 can indicate whether the software update 210 is outdated. In some examples, the response 138 can provide this indication via a flag. For instance, the response 138 may include a flag indicating whether the software update 210 is outdated. The flag may be set to “0” if it is outdated or “1” if it is not, or vice versa. In other examples, the response 138 can provide this indication by including a timestamp associated with a new update. For example, referring to FIG. 1, the response 138 may include a first timestamp 110 associated with the new update 108. If the first timestamp 110 associated with the new update 108 is newer than a second timestamp associated with the received update 210, it may indicate that the received update 210 is outdated.

In block 308, based on the response 138 indicating that that software update 210 is outdated, the processor 202 discards the software update 210. For example, the processor 202 can delete the software update 210 from the computing device 201. The processor 202 may also forego installing (e.g., reinstalling) the software update 210. This can help mitigate a freeze attack.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A non-transitory computer-readable medium comprising program code that is executable by one or more processors of a computing device for causing the computing device to perform operations including:
receiving a software update for a software program, wherein the software update is received from an update provider through a first communication channel;
based on receiving the software update, transmitting a request associated with the software update to a remote server through a second communication channel, the second communication channel being different from the first communication channel;
receiving a response to the request from the remote server, the response indicating that the software update is outdated; and
based on the response indicating that that software update is outdated, discarding the software update from the computing device without installing the software update.

2. The non-transitory computer-readable medium of claim 1, wherein the remote server is operated by a trusted third party that is different from the update provider.

3. The non-transitory computer-readable medium of claim 1, wherein the first communication channel includes a computer network, and the second communication channel excludes the computer network.

4. The non-transitory computer-readable medium of claim 1, wherein the response from the remote server includes a first timestamp associated with a more recent update for the software program than the received software update, and wherein the operations further comprise:
determining that the software update is outdated by comparing the first timestamp associated with the more recent update to a second timestamp associated with the software update, the first timestamp being more recent than the second timestamp; and
discarding the software update based on determining that the software update is outdated.

5. The non-transitory computer-readable medium of claim 4, wherein the operations further comprise:
receiving details about the software update from the update provider, the details indicating the first timestamp associated with the more recent update.

6. The non-transitory computer-readable medium of claim 1, wherein the response from the remote server includes a first unique identifier associated with a more recent update for the software program than the software update, and wherein the operations further comprise:
determining that the first unique identifier associated with the more recent update is different from a second unique identifier associated with the software update; and
discarding the software update based on determining that the first unique identifier is different from the second unique identifier.

7. The non-transitory computer-readable medium of claim 6, wherein the operations further comprise:
receiving details about the software update from the update provider, the details indicating the first unique identifier associated with the more recent update.

8. The non-transitory computer-readable medium of claim 1, wherein the operations further comprise:
blocklisting a unique identifier of the software update, such that future software updates associated with the unique identifier are automatically discarded from the computing device upon receipt without contacting the remote server again.

9. The non-transitory computer-readable medium of claim 1, wherein the request includes a timestamp associated with the software update and a unique identifier associated with the software update, the remote server being configured to:
determine whether the software update is a most recent update for the software program based on the timestamp and the unique identifier; and
based on determining that the software update is not the most recent update, transmit the response to the computing device.

10. The non-transitory computer-readable medium of claim 1, wherein the computing device is an electronic control unit (ECU) of a vehicle.

11. The non-transitory computer-readable medium of claim 1, wherein the response is a first response, and wherein the operations further comprise:
receiving a second response to the request from the remote server, the second response indicating that the software update is current; and
based on receiving the second response, installing the software update on the computing device.

12. The non-transitory computer-readable medium of claim 1, wherein the first communication channel uses a first communication protocol, and the second communication channel uses a second communication protocol that is different from the first communication protocol.

13. The non-transitory computer-readable medium of claim 12, wherein the first communication protocol is a first wireless communication protocol, and wherein the second communication protocol is a second wireless communication protocol.

14. A method comprising:
receiving, by a computing device, a software update for a software program, wherein the software update is received from an update provider through a first communication channel;
based on receiving the software update, transmitting, by the computing device, a request associated with the software update to a remote server through a second communication channel, the second communication channel being different from the first communication channel;
receiving, by the computing device, a response to the request from the remote server, the response indicating that the software update is outdated; and
based on the response indicating that that software update is outdated, discarding, by the computing device, the software update from the computing device without installing the software update.

15. The method of claim 14, wherein the remote server is operated by a trusted third party that is different from the update provider.

16. The method of claim 14, wherein the response from the remote server includes a first timestamp associated with a more recent update for the software program than the software update, and further comprising:
determining that the software update is outdated by comparing the first timestamp associated with the more recent update to a second timestamp associated with the software update, the first timestamp being more recent than the second timestamp; and
discarding the software update based on determining that the software update is outdated.

17. The method of claim 14, wherein the response from the remote server includes a first unique identifier associated with a more recent update for the software program than the software update, and further comprising:
determining that the first unique identifier associated with the more recent update is different from a second unique identifier associated with the software update; and
discarding the software update based on determining that the first unique identifier is different from the second unique identifier.

18. The method of claim 17, further comprising:
blocklisting the second unique identifier, such that future software updates associated with the second unique identifier are automatically discarded from the computing device without contacting the remote server again.

19. The method of claim 14, wherein the request includes a timestamp associated with the software update and a unique identifier associated with the software update, and wherein the remote server is configured to:
determine whether the software update is a most recent update for the software program based on the timestamp and the unique identifier; and
based on determining that the software update is not the most recent update, transmit the response to the computing device.

20. A computing device comprising:
a processor; and
a memory including instructions executable by the processor for causing the processor to perform operations including:
receiving a software update for a software program, wherein the software update is received from an update provider through a first communication channel;
based on receiving the software update, transmitting a request associated with the software update to a remote server through a second communication channel, the second communication channel being different from the first communication channel;
receiving a response to the request from the remote server, the response indicating that the software update is outdated; and
based on the response indicating that that software update is outdated, discarding the software update from the computing device without installing the software update.
